(19) United States
(12) Patent Application Publication
(10) Pub. No.: US 2026/0361096 A1
(43) Pub. Date: Nov. 12, 2026

(54) COMMUNICATION PROTOCOL TRANSITION VIA ELECTRIC VEHICLE SUPPLY EQUIPMENT CONTROL PILOT SIGNALING

(71) Applicant: FORD GLOBAL TECHNOLOGIES, LLC, Dearborn, MI (US)

(72) Inventors: Timothy Harris, Grosse Ile, MI (US); Kevin Stinnette, Monroe, MI (US)

(21) Appl. No.: 19/200,756

(22) Filed: May 7, 2025

(51) Int. Cl. H02J 7/40; B60L 53/66; H04B 3/54

(52) U.S. Cl. CPC H02J 7/40; B60L 53/66; H04B 3/54

(57) ABSTRACT

Techniques are provided for transitioning communication between electric vehicle supply equipment and a connected electric vehicle from unidirectional analog pulse-width modulation signaling to bidirectional digital LIN-based communication using a shared control pilot line. The electric vehicle supply equipment includes a processor and multi-pin connector and is configured to transmit a distinct signal—based on modifications to pulse-width modulation duty cycle, frequency, or voltage magnitude—that prompts the vehicle to initiate LIN-based communication. This transition can occur either before or during battery charging.

### TECHNICAL FIELD

This disclosure relates to vehicle charging.

### BACKGROUND

The SAE J1772 standard establishes the technical foundation for AC conductive charging of electric vehicles in North America, detailing the physical connector design, signaling methods, and other protocols that govern communication between the electric vehicle supply equipment (EVSE) and the electric vehicle (EV). The system includes a five-pin connector that includes two AC power lines (Line 1 and Line 2 or Neutral), a protective earth ground, a control pilot (CP), and a proximity pilot (PP). The control pilot serves as the main signaling channel, enabling coordination of charging readiness, communication of current limits through pulse-width modulation (PWM), and detection of electrical faults via voltage level monitoring. The PP complements this by providing passive resistance-based signals that indicate the presence of the charging cable, the insertion of the connector, and the status of the connection mechanism securing the connection.

SAE J3068 is a North American standard that defines the technical framework for AC conductive charging of EVs using three-phase power, primarily intended for medium-and heavy-duty commercial vehicles. It adapts the physical interface and signaling concepts from the IEC 62196 and IEC 61851 standards to align with North American grid configurations and other requirements. The standard supports both single-phase and three-phase AC charging at higher voltage and current levels than those typically supported by SAE J1772, allowing for faster energy transfer suitable for fleet and industrial applications. J3068 uses the same five-pin connector structure as Type 2 but incorporates adaptations to support local grounding practices and phase identification.

### SUMMARY

A charging system is provided that includes EVSE capable of transitioning communication with a connected electric vehicle from unidirectional analog pulse-width signaling to bidirectional digital communication, all over a shared CP line. Initially, the EVSE uses PWM signaling to convey current availability through analog duty cycles, but it is configured to transmit a specific signal over the CP line that triggers a switch to a digital protocol, specifically LIN-based control pilot communication. This transition signal may be transmitted either before the vehicle begins drawing current for battery charging or during an active charging session. The signal used to initiate the protocol switch may take various forms, including voltage pulses alternating between standard 1 kHz and non-standard frequencies (either higher or lower), pulses with reduced positive voltage magnitudes such as 9 volts, or sequences that alternate between different PWM duty cycles—for example, between 100% and a reduced value such as 7% to 8%.

A method is provided for enabling a transition from PWM-based control pilot communication to LIN-based digital communication between EVSE and a connected vehicle. The method involves altering characteristics of the signal transmitted over the control pilot line—specifically by modifying the duty cycle, frequency, or voltage magnitude of the signal. This alteration may occur either before the vehicle begins drawing charging current or during an active charging session. In various embodiments, the duty cycle may alternate between a higher value and a lower value (such as 100% and 7-8%), the frequency may switch between 1 kHz and a value above or below that threshold, or the positive voltage magnitude may be reduced from the standard 12 volts to a lower value such as 9 volts.

A vehicle is provided that includes a processor that initiates communication with EVSE using LIN-based digital communication in response to receiving a specific signal on the control pilot line. This transition to digital communication may occur either before the vehicle begins drawing current for charging or while charging is already in progress. The processor interprets the signal as an instruction to shift from traditional PWM signaling to bidirectional LIN-based messaging.

### BRIEF DESCRIPTION OF THE DRAWINGS

FIGS. 1A-3 are waveforms of control pilot signals.

FIG. 4 is a pulse width modulation-control pilot waveform.

FIG. 5 is a LIN-based control pilot waveform.

FIG. 6 is a block diagram of electric vehicle supply equipment and a vehicle.

### DETAILED DESCRIPTION

Detailed embodiments are provided below to illustrate aspects of the present disclosure. These embodiments are merely examples and may take various alternative forms. The figures are not necessarily drawn to scale—certain features may be exaggerated or reduced to better highlight specific components. As such, the structural and functional details described herein are not intended to be limiting, but rather serve as representative examples to guide those skilled in the art in applying the disclosed concepts in different contexts.

An EVSE system is often composed of several coordinated components that together enable standards-based EV charging. It typically includes a main controller, often a microcontroller or embedded processor, which acts as the brain of the system. This controller manages the signaling logic, user interface, monitoring, and power delivery coordination. Connected to it is the CP circuit, which generates and monitors the 1 kHz PWM signal defined by SAE J1772 or IEC 61851. This circuit typically includes a PWM driver, voltage divider, pull-up resistor, and diode network. The PP circuit is another signaling interface that detects the presence and connection status of the connector, using a resistor network and analog voltage sensing to determine whether the plug is inserted, connected, and what current-carrying capacity the cable supports.

The contactors are high-voltage electromechanical switches that physically connect or disconnect the AC or DC power lines (pins 1 and 2 in AC systems) from the power source to the vehicle. These are controlled by the main processor and only close once all checks pass. An insulation monitoring device (IMD) or ground fault detection circuit is typically included to verify the integrity of the earth ground connection (pin 3). The EVSE also includes current and voltage sensors that monitor real-time power delivery, allowing the controller to verify that the vehicle's current draw is within limits defined by the CP duty cycle—the percentage of each cycle during which the voltage is high (positive)—and to detect faults or overload conditions.

A power supply unit provides controlled low-voltage DC power to the EVSE electronics and interfaces, while the user interface module (e.g., display, LEDs, buttons, or RFID reader) allows the user to initiate, authorize, or monitor a charging session. In networked EVSE units, a communications module—often supporting Wi-Fi, Ethernet, cellular, or OCPP (Open Charge Point Protocol)—enables the EVSE to connect to backend systems for billing, monitoring, remote diagnostics, or smart grid coordination.

Physically, all of these components are enclosed in a weatherproof, tamper-resistant housing, often with thermal management provisions like fans or heatsinks. Together, these subsystems form a platform capable of handling power management and EV interoperability in accordance with global standards.

The AC Charging Startup Process as defined in the SAE J1772 standard involves a set of coordinated components that enable standardized communication and power transfer between an EV and EVSE. The physical interface for this process is the J1772 connector, which contains five electrically distinct pins as mentioned earlier, each serving a dedicated function in the charging interaction. Pins 1 and 2 are the AC power lines and are responsible for delivering the alternating current used to charge the vehicle's battery. Pin 3 is the Protective Earth or Ground.

Pin 4 is the CP, which is one of the two lines involved in communication. The CP line is a bidirectional signaling interface that originates from the EVSE and is used by both the EVSE and EV to signal connection status, readiness for charging, and allowable current limits. The EVSE applies a voltage to this line and senses changes in voltage or the presence of a PWM waveform to interpret the EV's state. Pin 5 is the PP, which is a passive sensing line that detects the presence and mechanical status of the connector, particularly whether it is inserted and connected. The PP circuit includes resistors inside the connector handle that vary depending on whether the connector is connected, and sometimes even the current rating of the cable assembly. This resistor network is read by the EVSE to determine whether it is appropriate to initiate the charging sequence.

Additional components involved in the process include internal switching elements within both the EV and the EVSE, such as relays or contactors that control the application of power to the AC lines. These are held open during the initial stages of the connection and only closed once the control logic determines that a proper connection has been established and that all conditions are met. Mechanical switches inside the connector handle are also involved, which change state when the user inserts the plug into the vehicle inlet and when the mechanism is pressed. These switches, connected to the PP line, allow the EVSE to detect the difference between an inserted but not connected plug and one that is fully engaged. On the EV side, diode and resistor circuits are connected to the CP line to signal vehicle presence and readiness by modifying the CP voltage. A diode is also used in the CP circuit for proper ground referencing and to allow the EVSE to detect faults such as missing or reversed ground. Altogether, these components form an electromechanical and electrical interface that enables standardized AC charging in a controlled manner.

The PWM-CP (Pulse Width Modulation-Control Pilot) protocol is a fundamental communication method used in EVSE to manage charging processes with EVs. It is primarily defined within the SAE J1772 and IEC 61851 standards and operates through the low-voltage CP signal that conveys charging states, current limits, and vehicle presence detection. The CP signal consists of a ±12V square wave with a duty cycle modulation, where the duty cycle percentage directly corresponds to the maximum current the EVSE is capable of supplying. For example, a 10% duty cycle typically represents a 6A charging current limit, while a 50% duty cycle indicates a 30A limit. This allows the EV to dynamically adjust its power draw based on the available supply and prevents overloading the grid. The protocol also incorporates resistive coding for proximity detection, enabling the EVSE to verify whether a vehicle is connected and whether the charging plug is properly engaged. Additionally, the CP signal facilitates state transitions, such as indicating whether the vehicle is ready to charge, actively charging, or requesting a charge termination. Other features include ground monitoring, where a diode and resistor combination in the vehicle ensures proper earthing before allowing current flow. The PWM-CP protocol is a component in AC charging scenarios.

State A of the AC Charging Startup Process represents the initial condition of the SAE J1772 AC charging process in which no connection has yet been made between the EVSE and EV. In this state, the EVSE is energized and continuously monitoring its output terminals, but there is no physical insertion of the connector into the vehicle's inlet. Electrically, each of the five pins in the J1772 connector is in a default, open state. Pins 1 and 2, which carry the AC power, are not connected, and no current flows. Pin 3, the Earth Ground, is also not yet connected, so there is no established common reference between the EVSE and the vehicle. Pin 4, the CP, remains at its default voltage level, which is approximately +12 volts DC, as imposed by the EVSE through a pull-up resistor and diode. This steady +12V is what the EVSE uses as a baseline to detect subsequent voltage changes initiated by the vehicle once a connection is made. Pin 5, the PP, is electrically open because the connector is not inserted and therefore its internal resistor network is not yet present in the circuit.

From the EVSE's perspective, this state is characterized by the absence of any load or response on either the CP or PP lines. The EVSE status is therefore listed as “Not Connected,” indicating it has detected no physical presence or signaling from a vehicle. Likewise, the EV status in this state is also “Not Connected,” reflecting that the vehicle has not engaged with the connector or begun any interaction with the EVSE. Functionally, this state is passive and forms the electrical baseline from which all subsequent connection states are detected. The state persists until the vehicle inlet makes physical contact with the connector's pins, and the first electrical connection occurs. The transition out of State A is triggered specifically by the connection of the Earth Ground pin, Pin 3, which completes the first part of the physical interface and enables the EVSE to proceed to monitor other signal changes on the CP and PP lines. The establishment of a solid earth connection is a prerequisite for further evaluation of the vehicle's presence and readiness to charge.

Steps 1 through 3 of the State A-B Transition in the SAE J1772 AC charging process describe the gradual mechanical and electrical engagement of the EVSE connector with the electric vehicle inlet. These steps define how the system detects and validates a secure physical connection before energizing any power lines.

In State A-B Transition, Step 1, the vehicle connector has been partially inserted into the EV inlet such that the ground pin (pin 3) makes contact, but the AC pins (pins 1 and 2), CP (pin 4), and PP (pin 5) may not yet be fully engaged. At this stage, the EVSE status for pins 1 and 2 shows “No Signal,” indicating no AC line continuity. The ground pin (pin 3), however, registers as “Earth Ground,” reflecting that a continuous earth connection has been established between the EVSE and the vehicle. This is a prerequisite, allowing the EVSE to begin monitoring voltages on the remaining pins relative to a known ground. The CP (pin 4) remains within its idle voltage range, typically measured by the EV as a DC voltage between 11.4 and 12.6 volts, indicating that the EVSE is not yet receiving any resistance or signaling load from the vehicle. The PP (pin 5) sees a voltage between −0.1 and 5 volts on the EVSE side and between 4.13 and 4.78 volts on the EV side, consistent with the plug being partially inserted and the mechanical connection still open.

In State A-B Transition, Step 2, the connector is inserted further, such that the ground pin remains connected and the AC lines (pins 1 and 2) now make contact. However, power is still not enabled. The EVSE continues to report “No Signal” on pins 1 and 2, meaning the internal contactors remain open and no voltage is present. The ground connection on pin 3 is still detected as “Earth Ground.” The CP (pin 4) voltage remains within the same monitoring range, between 11.4 and 12.6 volts, suggesting that the vehicle has not yet completed the signaling loop by adding the 2.74 kΩ resistor and diode that would pull the voltage down. This means the EV is still passive, waiting for full mechanical engagement before responding. The PP (pin 5) voltages remain largely unchanged from Step 1, again showing that the mechanism has not yet been engaged. These values—between −0.1 and 5 volts on the EVSE side and between 4.13 and 4.78 volts on the EV side—are consistent with a state where the plug is electrically present but the connection switch is still open.

In State A-B Transition, Step 3, the connector is now fully inserted and connected, meaning all five pins are engaged and the connection switch inside the connector is closed. This changes the circuit path on the PP, introducing a lower resistance that alters the voltage read by the EVSE. Specifically, the proximity voltage measured by the EVSE drops into the range of 2.38 to 3.16 volts, signaling that the connector is fully connected and the mechanism is held in place. The EVSE and EV continue to report “No Signal” on pins 1 and 2, confirming that the AC lines remain de-energized. Pin 3 remains grounded. The change in this step occurs on the CP line: the vehicle now introduces the 2.74 kΩ resistor and diode between the CP and ground, which drops the control pilot voltage on the EVSE side into a range between 8.36 and 9.59 volts DC. This voltage level is interpreted by the EVSE as “State B,” meaning that a vehicle is connected and is ready for communication, but has not yet requested to initiate charging. At this point, all five pins are physically engaged, the EVSE has confirmed a complete mechanical and electrical connection, and both sides are prepared to proceed into signaling and power enablement phases.

State B1 in the SAE J1772 charging sequence represents a condition where the connector remains fully inserted into the vehicle, but the mechanical mechanism that secures the connector has been released. This may occur when a user presses the button on the plug, intending to disconnect the charger, though the plug has not yet been physically removed. Electrically, all five pins remain connected: pins 1 and 2, the AC lines, are not yet energized, so the EVSE and the vehicle both report “No Signal” on these lines. Pin 3, the ground connection, remains securely established and is identified as Earth Ground on both the EVSE and EV sides. Pin 4, the CP, continues to carry a DC signal that reflects the presence of the 2.74 kΩ resistor and diode circuit from the vehicle, keeping the voltage within the 8.36 to 9.59 V range, which corresponds to “State B” per the J1772 standard.

A distinction in State B1 is the change in status on pin 5, the PP. Because the mechanism has been released, the internal switch that modifies the PP circuit has reopened, changing the effective resistance in the line. This results in a PP voltage drop, typically measured at the EVSE side within the range of 1.23 to 1.82 volts. This voltage level signals that the plug is still inserted but is no longer mechanically connected, and this status is internally interpreted by the EVSE as “Connection Released.” The EVSE recognizes this state and may inhibit further transition toward power delivery, though it does not consider this an error. The system can remain indefinitely in State B1 without generating a fault, which allows users to cancel a charging session before it begins by simply releasing the mechanism. No PWM signaling occurs in this state yet, and the EVSE remains in a passive monitoring role.

In State B2, the vehicle remains plugged in and all five pins are fully connected, including a properly secured mechanism, so pin 5 (PP) returns to the voltage range of 1.23 to 1.82 volts, confirming that the mechanism is held in. What distinguishes State B2 from B1 is that the EVSE has now initiated its oscillator circuit and begun generating a PWM signal on the CP line. This PWM waveform, typically a 1 kHz square wave, replaces the earlier fixed DC voltage on pin 4. The duty cycle of this PWM signal represents the maximum current that the EVSE is capable of supplying and may range from just above 9.5% to just below 96.5%. The presence of this modulated waveform is interpreted by the vehicle as an indication that the EVSE is ready and available for charging. The EV senses this PWM on pin 4, with voltage values that alternate between a high level in the 8.36 to 9.59 V range and a low level in the −12.6 to −11.4 V range. This negative swing below ground confirms the presence of the correct diode on the vehicle side, ensuring proper grounding and verifying that the CP loop is correctly configured.

Pins 1 and 2 remain unelectrified in this state, so both the EVSE and vehicle still report “No Signal” for those pins. Pin 3 remains connected to Earth Ground. Pin 5 continues to reflect a voltage in the 1.23 to 1.82 V range, corresponding to a connected connector. Thus, State B2 marks the beginning of active signaling between the EVSE and the vehicle, with the EVSE initiating the offer to deliver power and the EV still in a passive mode, awaiting its own conditions to be met before accepting energy. The next transition, if conditions allow, would be the vehicle indicating readiness by closing an internal switch, leading into the charging-ready state.

State C in the SAE J1772 charging sequence represents the moment when both the EVSE and the vehicle have confirmed readiness to begin power transfer, and the EVSE is now waiting to energize the AC lines. This readiness is determined when the vehicle closes its internal switch, referred to as S2, which indicates not only that the vehicle is ready to receive energy but also communicates any ventilation requirements—though in this specific version of the process, ventilation is not required. At this stage, the five connector pins remain fully engaged and connected. Pins 1 and 2, the AC lines, are still not energized, so both the EVSE and the vehicle report “No Signal” for these pins. Pin 3, the protective ground, remains connected and valid as Earth Ground. The Control Pilot (pin 4) continues to carry the PWM signal generated by the EVSE, with a duty cycle between 9.5% and 96.5%, signaling available current. On the EVSE side, the CP voltage cycles between a high level in the 5.47 to 6.53 volt range and a low level between −12.6 and −11.4 volts. These values confirm that the PWM waveform is properly grounded through the diode path in the vehicle. Pin 5, the PP, remains in the 1.23 to 1.82 volt range, indicating that the connector is connected. With these conditions met, the system is considered fully ready, and the EVSE can now close its internal contactors.

Upon closing the contactors, the process advances to State C2. In this state, the AC lines—pins 1 and 2—are now energized and ready to deliver power. The EVSE status changes to reflect “AC Voltage Present” on both pins 1 and 2, and the PEV reports the same. However, no current is yet flowing. Pin 3 remains grounded, pin 5 remains unchanged, and the CP (pin 4) continues carrying the same PWM signal with valid duty cycle and voltage swing. The transition to this state is nearly instantaneous—required to occur within a maximum of three seconds after vehicle readiness is detected—and represents the point at which the physical infrastructure is prepared for active energy transfer. Though voltage is present on the AC lines, the vehicle's onboard charger has not yet begun to draw current.

When the vehicle does begin to draw current from the energized AC lines, the process enters State C3. This state is characterized by active charging. Pins 1 and 2 now not only carry voltage but also support current flow, which is sensed by both the EVSE and the EV. The EVSE and EV status for these pins now reflect a current draw that is greater than zero but less than or equal to the maximum current allowed by the PWM duty cycle—mathematically, 0<i≤ipwm. Pin 3 remains Earth Ground, and pin 5 remains in the connected voltage range, indicating that the physical connection has not changed. The CP on pin 4 continues to carry the PWM waveform, unchanged from previous states unless an updated current capacity is signaled by the EVSE. The transition to this state indicates that energy is now being delivered to the vehicle's battery through the onboard charger, and the system is operating in steady-state charging mode.

As the charging session progresses, the system may enter State C4, which occurs if the EVSE needs to update its current delivery capability. This might happen due to grid-side limitations, load balancing, or thermal constraints. In this state, the EVSE modifies the duty cycle of the PWM waveform on the CP line (pin 4), thereby changing the encoded maximum current. The EVSE status on pins 1 and 2 remains “AC Voltage Present,” and the same is true for the EV. However, the EVSE now reports that the requested current ipwm has changed, and the EV must adjust its draw accordingly. Pin 3 continues to report Earth Ground, and pin 5 indicates the plug is connected. The CP waveform remains active, but the duty cycle is updated to reflect the new maximum current. The vehicle, upon detecting this PWM duty cycle change, has a maximum of five seconds to adjust its charging current to remain within the new limit. This closed-loop adjustment allows the EVSE to dynamically manage energy availability while maintaining adherence to operational thresholds defined in the standard.

State D in the SAE J1772 AC charging protocol represents a situation where both the EV and the EVSE are electrically and mechanically connected and have signaled mutual readiness to begin charging, but the vehicle has indicated that ventilation is required for charging. Ventilation may be needed in rare cases where battery chemistries or operating conditions could result in off-gassing. Like in State C, all five connector pins are fully engaged, connected, and functioning as expected. Pins 1 and 2, which carry the AC voltage, are still in the “No Signal” state, meaning the EVSE has not yet closed the contactors. Pin 3 remains continuously connected and reads as Earth Ground.

The CP (pin 4) in State D carries a PWM waveform from the EVSE with a duty cycle between 9.5% and 96.5%, just like in State C. However, the distinction is the low-level voltage range of the PWM signal. When the vehicle requires ventilation, it modifies its internal circuit such that the low voltage level of the PWM waveform stays within a positive DC voltage window—specifically between 2.58 and 3.28 volts. This is interpreted by the EVSE as a “ventilation required” flag. The high side of the PWM waveform remains in the normal 8.36-9.59 V range, and the negative swing between −12.6 and —11.4 V is still present. These voltage thresholds allow the EVSE to correctly interpret both the PWM duty cycle and the ventilation requirement. Pin 5,the PP, continues to show a voltage in the 1.23 to 1.82 V range, indicating that the connector remains connected. The EVSE recognizes that the vehicle is ready and ventilation is required, and if proper ventilation infrastructure is in place, the EVSE can proceed by closing its contactors and energizing the AC lines. This transition must occur within a 3-second window.

If the EVSE cannot fulfill the ventilation requirement, whether due to lack of equipment or a fault condition, it transitions instead to State D1. In this state, the EVSE acknowledges that the connection and signaling are intact, but it is not ready to proceed with charging. The indicator here is on the CP line. The vehicle maintains the low-side voltage between 2.58 and 3.28 V, but this is now DC only—the EVSE has ceased PWM generation entirely. That is, the PWM oscillator is turned off, and pin 4 carries a steady DC voltage instead of a modulated waveform. This absence of PWM indicates that the EVSE has entered a fault or standby mode and is intentionally withholding authorization to charge. Pins 1 and 2 still report “No Signal” as the contactors remain open. Ground is maintained on pin 3, and the PP (pin 5) remains in its connected range of 1.23 to 1.82 V. The transition to State D1 is not considered an error state, but it is a terminal condition unless ventilation requirements are removed or the EVSE is reconfigured to support them. This state effectively ends the charging attempt unless resolved by user or system action.

Currently, there are no automated solutions that enable a seamless transition from PWM-CP communication to LIN-based Control Pilot (LIN-CP) communication without human intervention. An existing method requires the user to physically unplug and reconnect the coupler, thereby initiating a new charging session that can be configured for LIN-CP. This disclosure proposes a mechanism for initiating LIN-CP communication from within an active PWM-CP session, including during States B or C of the SAE J1772 protocol. In one example, the EVSE maintains the CP voltage at 9 volts and modulates the PWM signal a defined number of times between duty cycles of 7-8% and 100%, at predetermined time intervals. This modulation pattern serves as a digital handshake request. Once the electric vehicle detects and recognizes this specific sequence, it interprets it as a request to begin LIN-CP communication. The vehicle then initiates the LIN-CP protocol and waits for the EVSE to respond with the appropriate start-up messages. Additional scenarios and variations of this transition mechanism are also considered and are described in further detail below.

A technical feature of J3068 is its support for two communication protocols over the CP line: traditional PWM-based signaling for backward compatibility and a LIN-CP (Local Interconnect Network-Control Pilot) digital signaling mode that enables richer data exchange between the EVSE and the EV. The LIN-CP protocol used in J3068 is not standard LIN bus but a LIN-like, single-wire communication method operating over the CP line to allow the exchange of parameters such as available voltage, phase configuration, and readiness status.

The LIN-CP protocol is an evolution of the traditional CP mechanism that incorporates low-speed digital communication to enhance data exchange between the EV and EVSE. It is particularly relevant in bidirectional charging applications, such as vehicle-to-grid (V2G) and vehicle-to-home (V2H) systems, where additional control and status information must be exchanged beyond the limitations of PWM-based signaling. Traditional LIN-CP extends the capabilities of conventional CP communication by leveraging the LIN bus, a single-wire communication standard that operates on a master-slave topology with a maximum data rate of 20 kbps. In this context, the EVSE acts as the LIN master, periodically polling the EV, which functions as the LIN slave, to exchange detailed charging parameters, battery status, state-of-charge (SoC) information, and grid interaction commands. Unlike PWM-CP, which relies on analog signaling, LIN-CP supports more granular control over the charging process, allowing for features such as demand-response management, dynamic pricing adaptation, and predictive maintenance insights. The digital nature of LIN-CP also enhances fault diagnostics by enabling real-time status updates and error reporting. Additionally, LIN-CP facilitates encrypted communication for authentication and cybersecurity. This protocol may be advantageous in DC fast charging and next-generation smart grid applications, where coordination between the EV, EVSE, and energy providers is of interest.

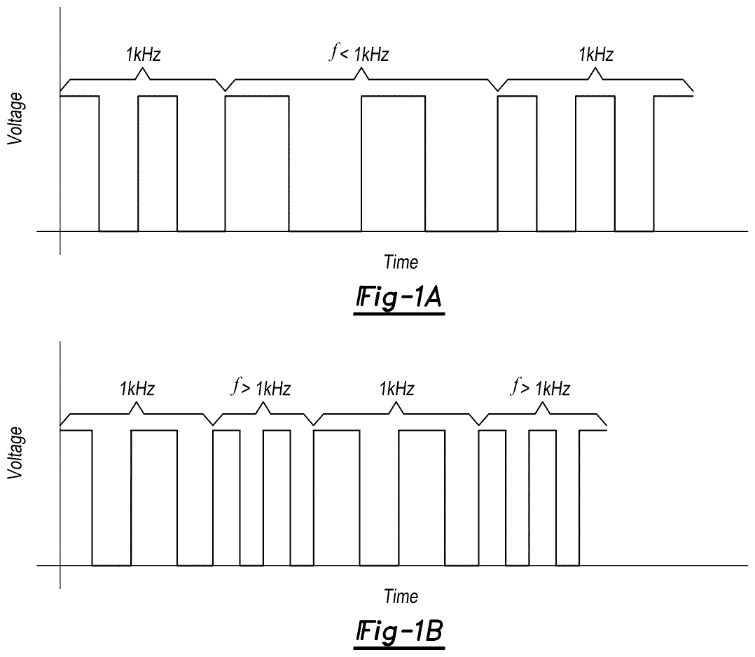

FIG. 1A illustrates a signaling strategy intended to initiate a transition from traditional PWM-CP communication to a digital LIN-CP protocol, using a deliberate and controlled variation in the frequency of the PWM signal. This strategy is designed for implementation during State C of the SAE J1772 charging process, a state in which both the EVSE and the EV are in an active charging session with the AC lines energized and current flowing within the bounds defined by the PWM duty cycle. Under normal circumstances in State C, the CP signal on pin 4 of the connector carries a 1 kHz square wave with a duty cycle that specifies the maximum current available to the vehicle, and the vehicle modulates its draw accordingly. In the proposed transition technique, the EVSE momentarily alters the frequency of the PWM waveform below the standard 1 kHz rate—dropping it to a clearly distinguishable but well-defined lower frequency—and then returns it to 1 kHz. This cycle of frequency changes is repeated in a specific pattern, such as alternating between 1 kHz and a lower frequency two or three times, with controlled timing intervals between transitions.

This intentional deviation from the expected steady 1 kHz signal acts as a unique digital signature that the vehicle's charging system can monitor for and interpret as a command to prepare for a protocol switch. The waveform shown in the figure captures this by plotting voltage over time, where the high and low voltage transitions represent the square wave of the PWM signal. The spacing between the transitions becomes wider during the low-frequency segments, indicating a frequency drop, and then returns to the narrower spacing typical of 1 kHz when the standard PWM resumes. To implement this signaling method, the EVSE firmware should be programmed to detect when the system is in a stable State C condition—i.e., all pins connected, ground and proximity circuits nominal, contactors closed, and current within limits—and then execute the predefined frequency variation routine. This routine should be constructed to remain within the boundaries of the standard while still providing an unmistakable signal distinguishable from normal PWM fluctuations or noise.

On the vehicle side, the onboard charger or interface controller should include logic to detect and recognize the frequency deviation pattern as a trigger. Once identified, the vehicle can then prepare to switch to LIN-CP mode, for example by deactivating its CP resistor load and initializing its LIN transceiver, while awaiting a digital handshake from the EVSE. After the final frequency transition, the EVSE ceases PWM signaling and begins LIN-CP communication over the CP line, using a LIN-like protocol defined in J3068. The entire sequence is designed to occur without human intervention or interruption to the charging session, enabling a dynamic mid-session switch to richer communication capabilities while adhering to signaling expectations of the J1772 interface.

FIG. 1B illustrates an alternative signaling strategy by briefly increasing the frequency of the PWM signal above the standard 1 kHz. This approach, like the previously discussed low-frequency method, is designed to be implemented during State C of the SAE J1772 protocol, where the EV and EVSE are actively engaged in a charging session with current flowing and the contactors closed. In this strategy, the EVSE begins by outputting the standard 1 kHz PWM signal, which the vehicle interprets as normal current availability signaling. To initiate the transition, the EVSE deliberately modulates the frequency of the PWM signal above 1 kHz for a defined number of cycles—such as 1.5 kHz or 2 kHz—before returning to the 1 kHz baseline. This pattern of increased frequency is repeated with a predictable timing structure to form a recognizable signature. The figure shows shorter intervals between the rising and falling edges of the voltage waveform during the high-frequency segments, indicating the increase in PWM frequency. This shortening of the PWM period is a distinguishing feature of the signal and should be configured to not be confused with high-frequency noise or EMI artifacts. On the vehicle side, the control unit continuously monitors the CP line and is programmed to detect this temporary increase in frequency as a predefined signal to prepare for a transition to LIN-CP. Once the sequence is complete, the EVSE stops PWM signaling and begins LIN communication over the same CP line.

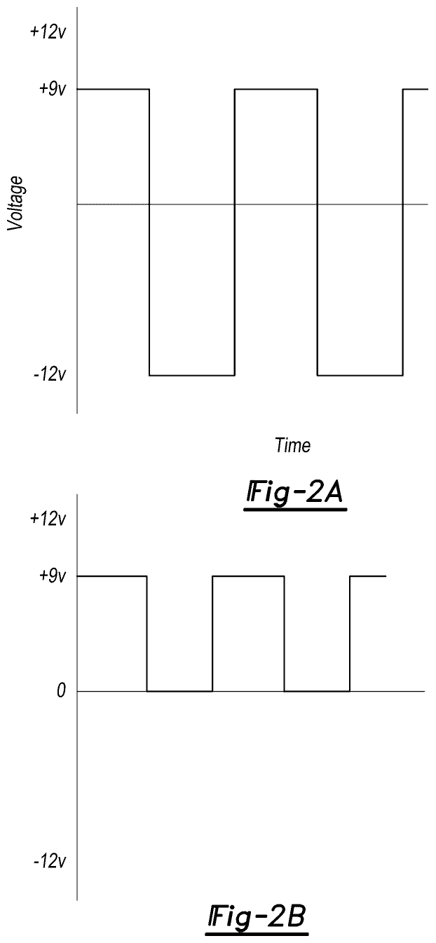

FIGS. 2A and 2B illustrate a voltage-based signaling strategy designed to initiate a transition from PWM-CP to LIN-CP communication during State B of the SAE J1772 charging process. In State B, the vehicle is connected and recognized by the EVSE, but no power has yet been enabled. This makes it a stable state for attempting protocol transition signaling. The diagram is divided into two halves. FIG. 2A is the EVSE's view of the CP voltage, showing a classic PWM waveform oscillating between +12 volts and −12 volts, with a duty cycle corresponding to a current limit. At this point, the EVSE is maintaining normal PWM-CP communication. On the right side, the waveform changes in shape—rather than continuing to swing between +12 and −12 volts, the signal now varies only between +9 volts and 0 volts, with the negative swing removed. From the vehicle's perspective, shown in FIG. 2B, the CP voltage transitions from a square wave oscillating between 12 volts and 0 volts to between 9 volts and 0 volts.

This technique takes advantage of the diode path required on the vehicle side in the CP circuit, which clips any negative voltage below ground. Under normal PWM operation, the EVSE-generated signal swings below ground to-12 volts, which passes through the diode and is interpreted by the vehicle as confirmation of proper earthing. When the EVSE instead swings between +9 volts and −12 volts, the vehicle recognizes a significant change in the nature of the CP signal. By toggling between normal +12 PWM and this altered +9 signal in a defined sequence—such as several brief cycles of full +12 PWM followed by several cycles of +9 PWM—the EVSE can encode a signature or pattern that the vehicle has been preprogrammed to interpret as an instruction to prepare for LIN-CP. Once this pattern is detected, the vehicle initiates its LIN communication stack and readies its transceiver. At the end of the signaling sequence, the EVSE ceases all PWM output and begins digital communication over the CP line using the LIN-CP protocol defined in J3068. Because this entire procedure occurs in State B, prior to energizing the power conductors, it allows for a controlled initiation of the digital protocol without disrupting power delivery or requiring the user to physically unplug and reconnect the coupler.

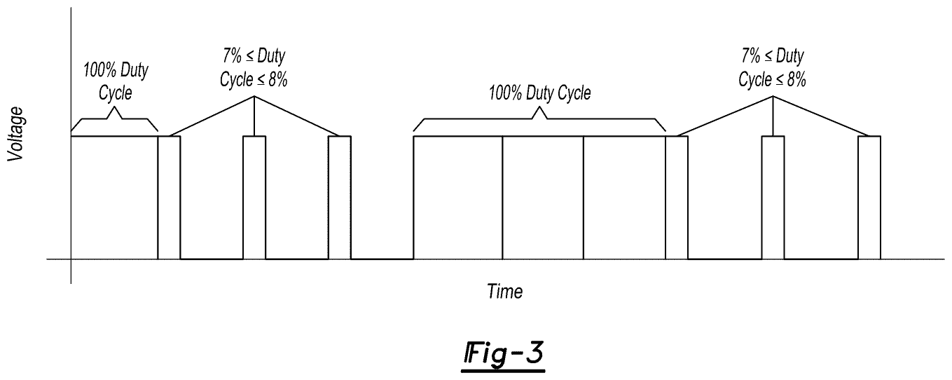

FIG. 3 illustrates another signaling method for initiating a transition from PWM-CP communication to LIN-CP by deliberately modulating the PWM duty cycle in a unique and recognizable pattern. This strategy can be implemented in either State B or State C of the SAE J1772 protocol. In both states, the EVSE and the EV have already established a connection and are exchanging standard CP signals, with State B being pre-power-delivery and State C representing active charging. The waveform in the figure shows the CO voltage switching between a 100% duty cycle and a reduced duty cycle in the 7% to 8% range, with this pattern repeating in a structured sequence. A 100% duty cycle corresponds to the CP line being held high continuously, which under normal circumstances is a special condition indicating a communication issue or fault, while a 7-8% duty cycle is just below the very bottom end of the allowed range.

To implement this transition strategy in State B, the EVSE begins with a standard 1 kHz PWM signal at a normal duty cycle corresponding to the available current. Then, to initiate the protocol shift, it alternates between short bursts of 100% duty cycle and 7-8% duty cycle. These are not randomly timed but follow a pre-agreed signaling pattern, such as three repetitions of 100%, then two cycles at 7%, followed by another two at 100%, and so on. Because a 100% and 7% duty cycle are outside normal operating conditions, the vehicle's CP monitoring logic is designed to recognize this unlikely sequence as a deliberate signal rather than a fluctuating current limit. Once the sequence is recognized, the vehicle ceases its CP resistor load and activates its LIN transceiver to begin receiving digital messages from the EVSE.

In State C, the same technique can be applied while current is flowing, though care must be taken to ensure the transitions are interpreted as communication cues and not as actual changes in current availability. During the signaling sequence, the vehicle should freeze its charging behavior or remain within certain current draw limits, recognizing that the CP duty cycle is being overridden temporarily for signaling purposes. Once the final part of the pattern is detected, and the duty cycle ceases altogether, the vehicle shifts to LIN mode, and the EVSE disables PWM output and initiates LIN-based digital communication on the same CP line. This method is effective because both the 100% and 7-8% duty cycles are allowed under the PWM scheme but rarely used in succession.

To implement a change from PWM-CP signaling to LIN-CP communication, the moment following the detection of the final pattern in the modulation is of interest. The underlying behavior of both the EV and EVSE should be at least somewhat synchronized, and the signal integrity on the CP line should be controlled. This process differs slightly depending on whether the system is in State B or State C of the SAE J1772 protocol.

In State B, the system is in a pre-power state: the EV is plugged in, the EVSE has verified presence via the standard diode-resistor pull-down, and the EVSE is sending a 1 kHz PWM waveform on the CP line, but the contactors for AC line power have not yet closed. In this state, the CP line is used exclusively for signaling. No high-voltage power is present on the AC lines (pins 1 and 2), making it a point for protocol switching. Once the EV detects the defined duty cycle modulation pattern (such as some of those described above), it interprets this as a signal that a protocol change is about to occur. Internally, the EV controller stops presenting the 2.74 kΩ plus diode pull-down that provides the detection voltage to the CP line and instead switches its control circuit to a high-impedance input state, allowing bidirectional communication for the upcoming LIN session. Simultaneously, the EV enables its LIN transceiver in standby or listening mode, ready to receive a wake-up or initialization message.

On the EVSE side, after transmitting the final expected variation, the control firmware disables its PWM generator on the CP output line. The 1 kHz oscillator is shut off, and the output stage is placed in either high-impedance or push-pull mode as required by the LIN physical layer. At this point, the CP wire is no longer operating under PWM signaling rules. Instead, it is now functioning as a single-wire digital communication bus compatible with the LIN-like signaling defined in SAE J3068. The EVSE sends a LIN wake-up pulse, followed by a master-requested frame such as an identification or status query, using the LIN protocol framing (break field, sync byte, ID plus data plus checksum). The EV, now operating in slave mode, responds with its device address, capabilities, voltage class, or any protocol-specific negotiation fields. The system can now proceed with digital configuration of the charging session, including current limits, phase matching (if applicable), and handshakes, prior to energizing the AC lines.

In State C, the system is already in an active charging state, with the AC lines energized and the vehicle drawing current. In this case, care should be taken during the protocol transition to ensure data integrity. Upon detecting the same duty cycle modulation pattern, the EV should first enter a hold state where it maintains a steady current draw—typically freezing any adjustment of the onboard charger's power electronics—to ensure that no abrupt changes in load occur while the control signaling transitions. The EV may optionally reduce charging current to zero to simplify the transition and minimize EMI or noise on the CP line during digital signaling.

Once ready, the EV deactivates its CP resistor-diode network just as in State B and enables its LIN transceiver on the CP line. However, in this case, the CP line is electrically more sensitive due to the presence of live AC voltage on pins 1 and 2. The EVSE should ensure that the LIN signaling is robust against any common-mode noise coupling from the power lines, which may require filtering or additional isolation in the transceiver design. After the EVSE terminates its PWM output, it initiates the LIN session as in State B with a wake-up sequence followed by a master query. The EV replies as expected, and the system can now perform mid-session renegotiation, such as dynamically adjusting the maximum allowable current, reporting faults, or transitioning to other smart charging behaviors. The difference in State C is that the EVSE should continue to monitor power delivery for issues during this communication period, and both sides should fall back to PWM-CP if the LIN session is not successful or times out. In both states, management of impedance, line termination, and signal timing are helpful for a standards-based transition from analog PWM signaling to digital LIN-based communication.

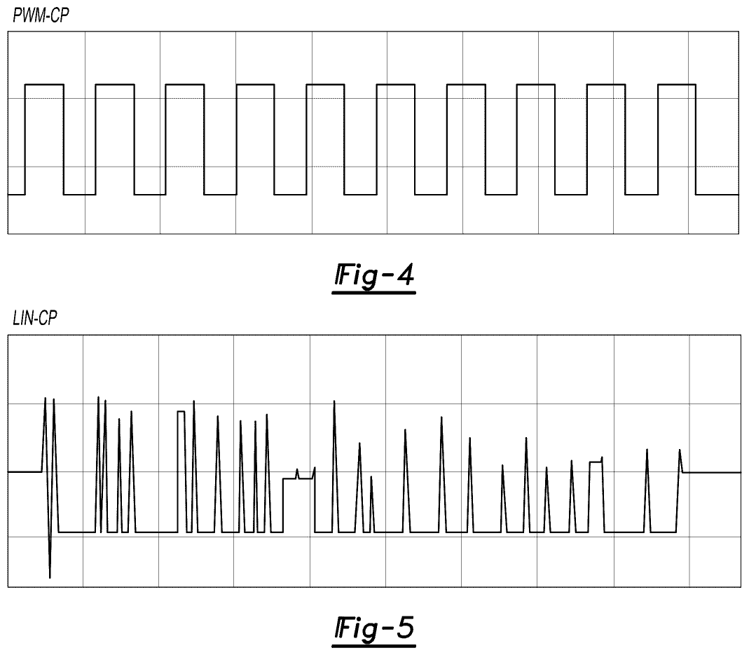

If an oscilloscope probe was arranged on the CP line during normal PWM-CP operation, the signal would appear, for example, as a repetitive square wave at a fixed frequency of 1 kHz, with voltage levels alternating between approximately +12V and −12V on the EVSE side as shown in FIG. 4. The waveform's duty cycle—the percentage of each cycle during which the voltage is high (positive)—would vary depending on the maximum current the EVSE is offering to the EV. For example, a 50% duty cycle corresponds to 30 amps available, while 16% corresponds to about 10 amps. On the vehicle side, due to the presence of a diode in the CP circuit, the waveform would be clipped below ground, so the negative swing would bottom out at around 0V instead of −12V. The result is a square wave ranging from about 0V to 12V, with sharp rising and falling edges and consistent timing. The signal would be clean and highly regular, repeating unless modified by the EVSE for signaling purposes.

When the system transitions to LIN-CP, the CP signal changes. Instead of a constant square wave, the oscilloscope would now show bursts of digital serial communication as shown in FIG. 5. The waveform may include asynchronous frames of varying length, beginning with a dominant low-level “break field,” followed by a synchronization byte, an identifier byte, and several data and checksum bytes, consistent with LIN protocol framing. The voltage levels would still operate between approximately +12V (recessive) and 0V (dominant), but the signal timing would reflect standard UART-like LIN encoding, not a fixed square wave. Between message bursts, the line may remain idle at around +12V. Unlike PWM-CP, which has a continuous and predictable waveform, the LIN-CP signal is intermittent and packet-based, with each message frame taking a few milliseconds and separated by longer idle intervals.

Therefore, observation of the CP line would detect the transition: the moment the steady waveform disappears and is replaced by bursty, asynchronous digital packets at a slower baud rate (typically around 9.6-20 kbps), indicating the system has switched from analog PWM signaling to digital LIN communication.

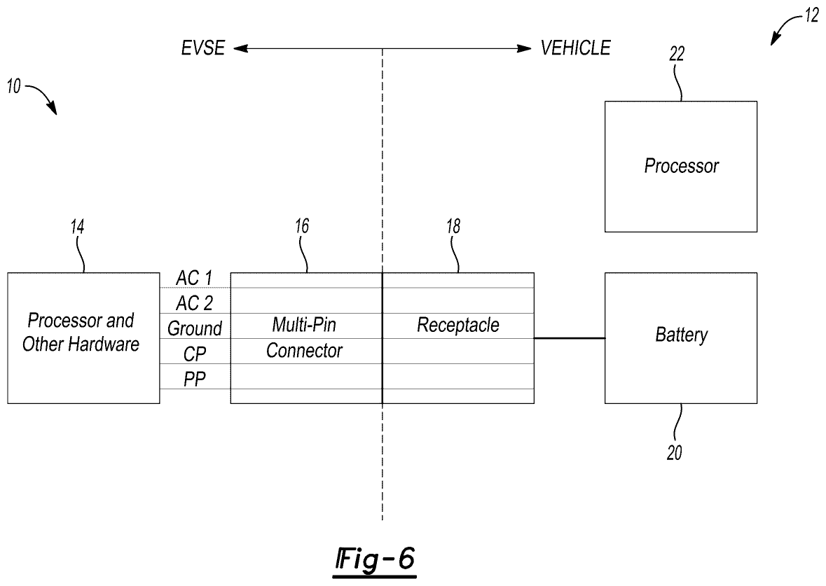

FIG. 6 provides a simplified view of the major electrical and signaling connections between an EVSE 10 and EV 12 during AC charging. The EVSE 10 has a processor and other hardware 14 and a multi-pin connector 16. The processor and other hardware 14 include a microcontroller, power electronics, relay drivers, monitoring circuits, and software logic responsible for generating the CP signal, interpreting PP feedback, and managing AC power delivery. Three primary power-related lines—AC 1, AC 2, and Ground—extend from the EVSE's internal circuitry and pass through the multi-pin connector 16. These lines are responsible for delivering single-or split-phase AC power from the EVSE 10 to the vehicle's onboard charger.

The CP and PP lines also originate from the EVSE hardware and travel alongside the power lines within the same multi-pin connector 16. The CP line carries signaling waveforms such as the 1 kHz PWM signal used for current negotiation and state detection under SAE J1772, or alternatively LIN-CP communication when supported. The PP line carries passive signaling through voltage division, typically used to detect cable connection status and mechanical mechanism engagement. All these lines—power, ground, CP, and PP—pass through the EVSE's connector interface,” which mates with the vehicle-side receptacle 18.

On the vehicle side, the receptacle 18 interfaces directly with the corresponding lines from the EVSE 10. The AC 1 and AC 2 lines connect internally to the vehicle's onboard charger and then to battery 20, where the AC power is rectified and conditioned for storage. The ground line establishes a reference potential shared between the EVSE 10 and EV 12. The CP line routes to the vehicle's control electronics, where it is terminated through a diode and resistor network used for signaling conformance, and it may also connect to a LIN transceiver if LIN-CP communication is supported. The PP line connects to a resistive circuit in the connector assembly that reflects the plug status back to the EVSE 10.

Processor 22 is in communication with the receptacle 18 and battery 20, and exerts control over the same. The processor 22 is programmed to recognize the altered CP signals and transition from PWM-CP to LIN-CP as described above.

The algorithms, methods, and processes described herein may be implemented by or delivered to a computer, controller, or processing device, including any dedicated or programmable electronic control unit. These implementations can be stored as data and executable instructions in various forms, such as on non-writable storage media like read-only memory (ROM), or on writable media such as compact discs, random access memory (RAM), and other magnetic or optical storage devices. The functionality may be executed as software objects, or alternatively, realized partially or entirely through hardware components such as application-specific integrated circuits (ASICs), field-programmable gate arrays (FPGAs), state machines, or other hardware-based systems. In some cases, a combination of hardware, software, and firmware may be used to perform the described functionality.

While example embodiments have been described above, they are not intended to represent all possible implementations. The terminology used in this specification is meant to illustrate, not to limit, the scope of the disclosed subject matter. The terms “processor” and “processors,” for example, can be used interchangeably herein. It is understood that various modifications and adaptations may be made without departing from the underlying principles and intended scope. Additionally, features from different embodiments may be combined in various ways to create additional implementations.

What is claimed is:

1. A charging system comprising:
electric vehicle supply equipment including a control pilot line and configured to, when connected with a vehicle, transmit a signal to the vehicle via the control pilot line resulting in the electric vehicle supply equipment and vehicle transitioning from unidirectional analog pulse width modulation signaling via the control pilot line to bidirectional digital communication via the control pilot line.

2. The charging system of claim 1, wherein the unidirectional analog pulse width modulation signaling is pulse width modulation-control pilot signaling.

3. The charging system of claim 1, wherein the bidirectional digital communication is LIN-based control pilot communication.

4. The charging system of claim 1, wherein the electric vehicle supply equipment is further configured to transmit the signal before the vehicle draws current from the electric vehicle supply equipment to charge a battery of the vehicle.

5. The charging system of claim 1, wherein the electric vehicle supply equipment is further configured to transmit the signal while the vehicle is drawing current from the electric vehicle supply equipment to charge a battery of the vehicle.

6. The charging system of claim 1, wherein the signal includes voltage pulses alternating between a frequency of 1kHz and a frequency greater than 1kHz or less than 1kHz.

7. The charging system of claim 1, wherein the signal includes voltage pulses having a positive magnitude less than 12 volts.

8. The charging system of claim 7, wherein the positive magnitude is 9 volts.

9. The charging system of claim 1, wherein the signal includes voltage pulses alternating between a duty cycle having a first value and a duty cycle having a second value less than the first value.

10. The charging system of claim 9, wherein the first value is 100% and the second value is between 7% and 8%.

11. A method comprising:
altering a duty cycle, frequency, or magnitude of a signal carried by a control pilot line of electric vehicle supply equipment connected with a vehicle such that the electric vehicle supply equipment and vehicle transition from pulse width modulation-control pilot signaling to LIN-based control pilot communication.

12. The method of claim 11, wherein the altering occurs before the vehicle draws current from the electric vehicle supply equipment to charge a battery of the vehicle.

13. The method of claim 11, wherein the altering occurs while the vehicle is drawing current from the electric vehicle supply equipment to charge a battery of the vehicle.

14. The method of claim 11, wherein the altering the duty cycle includes alternating the duty cycle between a first value and a second value less than the first value.

15. The method of claim 11, wherein the altering the frequency includes alternating a frequency of voltage pulses between 1 kHZ and a value greater or less than 1 kHz.

16. The method of claim 11, wherein the altering the magnitude includes reducing a positive voltage magnitude to a value less than 12 volts.

17. A vehicle comprising:
a processor programmed to, responsive to transmission of a signal on a control pilot line of electric vehicle supply equipment connected with the vehicle, communicate with the electric vehicle supply equipment via LIN-based control pilot communication.

18. The vehicle of claim 17, wherein the transmission occurs before the vehicle is drawing current from the electric vehicle supply equipment.

19. The vehicle of claim 17, wherein the transmission occurs while the vehicle is drawing current from the electric vehicle supply equipment.

20. A method comprising:
responsive to transmission of a pilot signal from electric supply equipment, communicating with the electric supply equipment via LIN-based control pilot communication.
